(19) United States
(12) Patent Application Publication
(10) Pub. No.: US 2017/0203384 A1
(43) Pub. Date: Jul. 20, 2017

(54) METHODS AND SYSTEMS FOR RECYCLING CARBON FIBER

(71) Applicant: EAST CHINA UNIVERSITY OF SCIENCE AND TECHNOLOGY, Shanghai (CN)

(72) Inventors: Chongjun Zhao, Shanghai (CN); Youfu Huang, Shanghai (CN); Jianbo Dong, Shanghai (CN); Jinchao Zhang, Shanghai (CN); Xiuzhen Qian, Shanghai (CN); Yunlong Xu, Shanghai (CN)

(73) Assignee: EAST CHINA UNIVERSITY OF SCIENCE AND TECHNOLOGY, Shanghai (CN)

(21) Appl. No.: 15/313,873

(22) PCT Filed: May 30, 2014
(86) PCT No.: PCT/CN2014/078985

§ 371 Date: Nov. 23, 2016

(51) Int. Cl. B23K 26/00; B23K 26/08; B23K 26/082; B01J 19/12; D01F 9/12

(52) U.S. Cl. CPC B23K 26/0006; B01J 19/121; D01F 9/12; B23K 26/0821; B23K 26/083; B29K 2105/06

(57) ABSTRACT

Methods for recycling carbon fibers are disclosed. The methods can include providing at least one object comprising carbon fibers and resin, and contacting the object with at least one light beam to produce recycled carbon fibers. Systems that implement the disclosed methods are also provided.

### BACKGROUND

Unless otherwise indicated herein, the materials described in this section are not prior art to the claims in this application and are not admitted to be prior art by inclusion in this section.

Carbon fiber reinforced polymers (CFRPs) have been widely used in aeronautics, aerospace, automobiles and sports products, due to their light weight and high strength. However, CFRPs can be difficult to recycle due to their multi-phase nature, usually containing at least carbon fibers and polymer resin matrix. The polymer resins used in CFRPs generally include crosslinked thermoset polymers that can be insoluble in many solvents and resistant to melting. As a result, the effective treatment of CFRPs has become a challenge. The European Union has promulgated related acts which prohibit landfill treatment of CFRPs (EU 1999/31/EC; EU 2000/53/EC), because such behavior would not only cause environmental pollution, but also result in the wastage of carbon fibers. Under these circumstances, the recycling of carbon fibers from CFRPs has become highly attractive both from an economic perspective and from an environmental perspective.

Presently, methods used for recycling carbon fibers from CFRPs are mechanical pulverization methods, chemical solvent methods, pyrolysis methods, and supercritical fluid methods. While each of these methods possesses benefits, the focus of these methods has been primarily on recycling small pieces of carbon fiber materials. Additionally, each method has different drawbacks. For example, the use of chemical solvent methods can produce large amounts of secondary pollution, such as liquid waste of organic solvents after the recycling process. Carbon fibers recycled by mechanical pulverization methods are typically short in length with low added value. Supercritical methods require simultaneous control of both temperature and pressure which may render the operation difficult. Pyrolysis methods require rigorous control of temperature and atmosphere. Accordingly, there is a need for simple, effective methods for recycling carbon fiber from CFRPs.

### SUMMARY

Embodiments disclosed herein describe methods and systems of recycling carbon fibers. The methods can include providing at least one object comprising carbon fibers and resin; and contacting the object with at least one light beam to produce recycled carbon fibers. In some embodiments, the method can consist essentially of the providing step and the contacting step. In other embodiments, the method can consist of the providing step and the contacting step. In some embodiments, the method can further include attaching the object onto at least one support surface. The systems can include at least one support surface configured to attach to an object, the object comprising carbon fibers and resin; and at least one light source configured to contact the object with a light beam to produce recycled carbon fibers.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 is a flow diagram illustrating a non-limiting example of a method of recycling carbon fiber.

FIG. 2 is a schematic diagram illustrating a non-limiting example of a method of recycling carbon fiber by fixing a piece of carbon fiber reinforced polymer vertically onto a sample stage configured to move three-dimensionally, and irradiating the piece with a light beam produced from a carbon dioxide laser.

FIG. 3 is a schematic diagram illustrating a non-limiting example of a method of recycling carbon fiber by fixing a piece of carbon fiber reinforced polymer horizontally onto a sample stage configured to move three-dimensionally, and irradiating the piece with a light beam produced from a carbon dioxide laser.

FIG. 4 is a schematic diagram illustrating a non-limiting example of a method of recycling carbon fiber by fixing a piece of carbon fiber reinforced polymer horizontally onto a sample stage configured to move three-dimensionally, and irradiating the piece with a light beam produced from an optical fiber laser.

FIGS. 5A and 5B are scanning electron microscope (SEM) images of recycled carbon fibers obtained by irradiating a piece of carbon fiber reinforced polymer with a light beam produced from a carbon dioxide laser.

FIG. 6 is a plot showing the thermogravimetric analysis (TGA) of carbon fibers recycled by irradiating a piece of carbon fiber reinforced polymer with a light beam produced from a carbon dioxide laser. The x-axis is temperature in ° C., and the y-axis is TG percentage. The dashed line is before treatment, and the solid line is after treatment.

FIGS. 7A and 7B are scanning electron microscope (SEM) images of carbon fibers obtained by irradiating a piece of carbon fiber reinforced polymer with a light beam produced from a carbon dioxide laser and moving a sample stage in a three-dimensional space.

FIG. 8 is a plot showing the thermogravimetric analysis (TGA) of carbon fibers recycled by irradiating a piece of carbon fiber reinforced polymer with a light beam produced from a carbon dioxide laser and moving a sample stage in a three-dimensional space. The x-axis is temperature in ° C., and the y-axis is TG percentage. The dashed line is before treatment, and the solid line is after treatment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Carbon fiber reinforced polymers (CFRPs) have significant applications in aeronautics, aviation, automobiles and sports products. Light beams produced from high powered laser devices, such as carbon dioxide (CO₂) lasers, optical fiber lasers and argon ion lasers, have good thermal effect. They have also been widely used in various industrial manufacturing processes, such as metal welding, brazing, soldering, boring and cutting. The corresponding thermal effect of these laser devices can be used to perform in-situ treatment of carbon fiber reinforced polymers. The thermal effect can also be used in combination with the scanning motion of the light beam produced from a laser on the CFRP provided on a support surface. This motion can be the motion of the support surface in a three-dimensional space, or the motion of the light beam produced from the laser itself in a three-dimensional space. In some situations, as the CFRP sample itself does not move (instead the support surface, the light beam or both, would move), long and well-ordered carbon fibers with properties that are substantially comparable to virgin carbon fibers can be obtained. Moreover, small pieces of polymer resin that are peeled off from the surface of the CFRP sample during the in-situ treatment can be blown away from the CFRP sample by a hot airflow formed by irradiating the CFRP sample with the light beam, thereby reducing the volume of sample as the treatment proceeds. Due to the reducing volume of the CFRP sample to be treated, the duration of the treatment period can be shortened. The shortened treatment period can also reduce damage to the carbon fibers.

Disclosed herein are methods and systems for recycling carbon fibers. The carbon fibers can be small pieces of carbon fiber or large pieces of carbon fiber, measuring several square meters or larger. The methods described herein can be simple and easy to operate. As will be described herein, the method can be as simple as contacting an object that includes carbon fibers and resin, with a light beam to effectively and rapidly recover the carbon fibers from the object. The object can for example include a CFRP. The carbon fibers that are recovered have been shown to be substantially free of surface defects, maintain a uniform and orderly orientation, and be substantially separated from the resin. Moreover, the equipment for recovering the carbon fibers can be inexpensive. Although not necessary, the methods can be combined with other techniques, such as optical techniques. The methods disclosed herein can be used to effectively recover the recycled carbon fibers while maintaining an ordered orientation of the fibers which gives the fibers their structural integrity, and maintaining the stability of the carbon fibers such that the carbon fibers are not destroyed under laser irradiation. The methods described herein can also be used to effectively remove resin from objects containing carbon fibers and resin, such as CFRPs.

### Methods for Recycling Carbon Fibers

In some embodiments, the method for recycling carbon fibers includes providing at least one object including carbon fibers and resin; and contacting the object with at least one light beam to produce recycled carbon fibers. In some embodiments, the contacting can be performed in the absence of one or more solvents, and/or in the absence of mechanical shearing or chopping. In some embodiments, the method can consist essentially of the providing step and the contacting step. In some embodiments, the method can consist of the providing step and the contacting step.

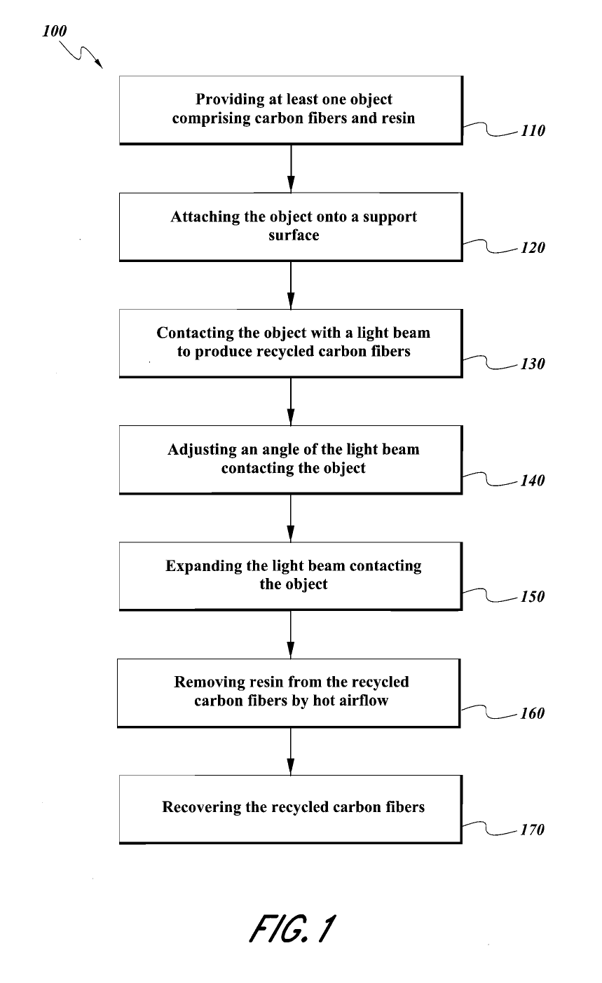

A non-limiting example of the method 100 for recycling carbon fibers in accordance with the present disclosure is illustrated in the flow diagram shown in FIG. 1. As illustrated in FIG. 1, the method 100 can include one or more functions, operations or actions as illustrated by one or more operations 110-170.

Method 100 can begin at operation 110, “Providing at least one object that includes carbon fibers and resin.” Operation 110 can be followed by operation 120, “Attaching the object onto a support surface.” Operation 120 can be followed by optional operation 130, “Contacting the object with a light to produce recycled carbon fibers.” Operation 130 can be followed by optional operation 140, “Adjusting an angle of the light contacting the object.” Operation 140 can be followed by optional operation 150, “Expanding the light beam contacting the object.” Operation 150 can be followed by optional operation 160, “Removing resin from the recycled carbon fibers.” Operation 160 can be followed by optional operation 170, “Recovering the recycled carbon fibers.”

In FIG. 1, operations 110-170 are illustrated as being performed sequentially with operation 110 first and operation 170 last. It will be appreciated, however, that these operations can be combined and/or divided into additional or different operations as appropriate to suit particular embodiments. For example, additional operations can be added before, during or after one or more operations 110-170. In some embodiments, one or more of the operations can be performed at about the same time. In some embodiments, the method only consists of operations 110 and 130, but not any other operations. In some embodiments, the method consists essentially of operations 110 and 130.

At operation 110, “Providing at least one object that includes carbon fibers and resin,” the object comprising carbon fibers and resin is not particularly limited. In some embodiments, the object can include carbon fiber reinforced polymers (CFRP). The size of the carbon fiber contained in the object is not particularly limited. In some embodiments, the object can include a small piece of carbon fiber. For example, the width or the length of the small piece of carbon fiber can be less than or equal to about 14 cm. The size of the small piece of carbon fiber can be less than or equal to about 14 cm by 3 cm. In other embodiments, the object can include a large piece of carbon fiber. For example, the width or the length of the carbon fiber can be equal to or greater than about 1 m. The size of the large piece of carbon fiber can be greater than or equal to about 1 m by 1 m. In some embodiments, the resin is a thermoset resin or a thermoplastic polymer. Non-limiting examples of the resin include epoxy, polyester, vinyl ester, nylon, phenolic, and urea. The object may further include other components, such as aramid fiber, aluminum fiber, glass fiber, or any combination thereof.

At optional operation 120, “Attaching the object onto a support surface,” the orientation of the object on a support surface is not particularly limited. In some embodiments, the object can be attached substantially vertical to the support surface. In some embodiments, the object can be attached substantially horizontal to the support surface. In some embodiments, the object can be attached substantially perpendicular to the direction of the light beam. In some embodiments, the support surface includes a sample stage configured to move three-dimensionally. In some embodiments, the object can be fixed on the sample stage. In some embodiments, the sample stage can move in the X-axis, Y-axis, Z-axis, or any combination thereof. In some embodiments, the support surface can be a supporting surface for the object.

At operation 130, “Contacting the object with a light beam to produce recycled carbon fibers,” contacting the object with the light beam can be performed. For example, the object can be contacted with the light beam in the absence of a solvent, or in the absence of mechanical shearing or chopping. In some embodiments, contacting the object with the light beam can include irradiating the object with the light beam. The amount of time for which the object is irradiated is not particularly limited. For example, the object can be irradiated by the light beam for at least about 3 minutes. In some embodiments, the object can be irradiated with the light beam by applying the light beam to the object for about 3 minutes to about 7 minutes. For example, the object can be irradiated with the light beam by applying the light beam to the object for about 3 minutes, about 4 minutes, about 5 minutes, about 6 minutes, about 7 minutes, about 8 minutes, about 9 minutes, about 10 minutes, about 15 minutes, about 20 minutes, about 30 minutes, or a time period between any two of these values. In some embodiments, the object can be irradiated with the light beam by applying the light beam to the object for about 5 minutes. In some embodiments, the object can be irradiated with the light beam by applying the light beam to the object for at least about 7 minutes.

The source from which the light beam is produced is not particularly limited. In some embodiments, the light beam includes a focused beam of sunlight. For example, the light beam can be reflected sunlight, transmitted light, or both. In some embodiments, the light beam is produced from a laser. The type of laser that can be used in the methods disclosed herein is not particularly limited. Any known laser may be used in the methods disclosed herein. For example, the laser can be a carbon dioxide laser, an optical fiber laser, an argon ion laser, or a combination thereof. The power of the light beam produced from the laser can vary. For example, the power can be at least about 30 watts (W). In some embodiments, the light beam produced from the laser can have a power of about 30 W to about 10000 W. For example, in some embodiments, the light beam produced from the laser can have a power of about 30 W, about 32 W, about 34 W, about 36 W, about 38 W, about 40 W, about 42 W, about 44 W, about 46 W, about 48 W, about 50 W, about 60 W, about 70 W, about 80 W, about 90 W, about 100 W, about 110 W, about 120 W, about 140 W, about 160 W, about 180 W, about 200 W, about 300 W, about 400 W, about 500 W, about 1000 W, about 2000 W, about 3000 W, about 4000 W, about 5000 W, about 6000 W, about 7000 W, about 8000 W, about 9000 W, about 10000 W, or a power between any two of these values. In some embodiments, the light beam produced from the laser can have a power of about 50 W to about 200 W. In some embodiments, the light beam produced from the laser can have a power of 30 W to 10000 W.

In some embodiments, an infrared thermometer can be used to measure the temperature of the light beam produced from the laser. The temperature of the light beam produced from the laser is not particularly limited. For example, the light beam produced from the laser can have a temperature of about 300° C. to about 600° C. For example, the light beam produced from the laser can have a temperature of about 300° C., 350° C., about 400° C., about 450° C., about 500° C., about 550° C., about 600° C. or a temperature between any two of these values. In some embodiments, the light beam produced from the laser can have a temperature of at least about 300° C., at least about 350° C., at least about 400° C., at least about 450° C., at least about 500° C., at least about 550° C., or at least about 600° C. In some embodiments, the light beam produced from the laser can have a temperature of 300° C. to 600° C.

The wavelength of the light beam produced by the laser is not particularly limited. For example, the light beam produced from the laser can have a wavelength of about 1.0 μm to about 10.7 μm. In some embodiments, the wavelength of the light beam produced from the laser can be about 1.0 μm, about 1.2 μm, about 1.4 μm, about 1.6 μm, about 1.8 μm, about 2.0 μm, about 3.0 μm, about 4.0 μm, about 5.0 μm, about 6.0 μm, about 7.0 μm, about 8.0 μm, about 9.0 μm, about 10.0 μm, about 10.1 μm, about 10.2 μm, about 10.3 μm, about 10.4 μm, about 10.5 μm, about 10.6 μm, about 10.7 μm or a wavelength between any two of these values. In some embodiments, the wavelength of the light beam produced from the laser is about 1.0 μm to about 10.7 μm.

In some embodiments, the ablation rate of the light beam on the object can be determined according to the size of the light beam, the power of the laser used, and the desired treatment requirements. The ablation rate at which the light beam produced from the laser is applied to the object is also not particularly limited. In some embodiments, the light beam produced from the laser is applied to the object at a linear speed. In some embodiments, the light beam produced from the laser can contact the object at an ablation rate of about 1 cm/minute to about 2 cm/minute. For example, the light beam produced from the laser can be applied to the object at an ablation rate of about 1 cm/minute, about 1.1 cm/minute, about 1.2 cm/minute, about 1.3 cm/minute, about 1.4 cm/minute, about 1.5 cm/minute, about 1.6 cm/minute, about 1.7 cm/minute, about 1.8 cm/minute, about 1.9 cm/minute, about 2 cm/minute, or a rate between any two of these values.

In some embodiments, operation 130, “Contacting the object with a light beam to produce recycled carbon fibers,” contacting the object with the light beam can include moving a support surface that the object is attached onto, the light beam or both. The velocity at which the support surface, the light beam or both is moved is not particularly limited. For example, in some embodiments, the support surface can be moved relative to the light beam at a velocity of about 1 cm/minute to about 2 cm/minute. In some embodiments, the support surface can be moved relative to the light beam at a velocity of about 1 cm/minute, about 1.1 cm/minute, about 1.2 cm/minute, about 1.3 cm/minute, about 1.4 cm/minute, about 1.5 cm/minute, about 1.6 cm/minute, about 1.7 cm/minute, about 1.8 cm/minute, about 1.9 cm/minute, about 2 cm/minute, or a velocity between any two of these values. In some embodiments, the light beam can be moved relative to the support surface at a velocity of about 1 cm/minute to about 5 cm/minute. For example, in some embodiments, the light beam can be moved relative to the support surface at a velocity of about 1 cm/minute, about 1.1 cm/minute, about 1.2 cm/minute, about 1.3 cm/minute, about 1.4 cm/minute, about 1.5 cm/minute, about 1.6 cm/minute, about 1.7 cm/minute, about 1.8 cm/minute, about 1.9 cm/minute, about 2 cm/minute, about 2.2 cm/minute, about 2.4 cm/minute, about 2.6 cm/minute, about 2.8 cm/minute, about 3.0 cm/minute, about 3.2 cm/minute, about 3.4 cm/minute, about 3.6 cm/minute, about 3.8 cm/minute, about 4.0 cm/minute, about 4.2 cm/minute, about 4.4 cm/minute, about 4.6 cm/minute, about 4.8 cm/minute, about 5.0 cm/minute, or a velocity between any two of these values. In some embodiments, moving the light beam can include moving an optical fiber of an optical fiber laser. The velocity at which the optical fiber of the laser is moved is not particularly limited and can be as described above for the velocity of the light beam with respect to the support surface.

In some embodiments, the method can consist essentially of operation 110, “Providing at least one object that includes carbon fibers and resin,” and operation 130, “Contacting the object with a light to produce recycled carbon fibers.” In some embodiments, the method can consist of operation 110, “Providing at least one object that includes carbon fibers and resin,” and operation 130, “Contacting the object with a light to produce recycled carbon fibers.”

At optional operation 140, “Adjusting an angle of the light contacting the object,” adjusting an angle of the light contacting the object can include adjusting the angle of the light using an optical device that can adjust the angle of the light. For example, a reflective mirror can be used to adjust the angle of the light.

Where the light is a light beam produced from a laser, optional operation 150, “Expanding the light beam contacting the object,” may be performed. Expanding the light beam contacting the object can include expanding the light beam using an optical device that can expand the size of the light beam. For example, a beam expander can be used to expand the size of the light beam. In some embodiments, the beam expander is a laser beam expander. In some embodiments, the laser beam expander is a carbon dioxide laser beam expander.

The methods disclosed herein can include, in some embodiments, optional operation 160, “Removing resin from the recycled carbon fibers.” The method of removing the resin from the recycled carbon fibers is not particularly limited. For example, the resin can be removed from the recycled carbon fibers by hot airflow. In some embodiments, the resin can be epoxy resin from within the carbon fiber sample. In some embodiments, the hot airflow can be formed by contacting air between the produced recycled carbon fibers and the light source with the light beam. In some embodiments, the light beam is produced from a laser. The type of laser that can be used in the methods disclosed herein is not particularly limited. For example, the laser can be a carbon dioxide laser, an optical fiber laser or an argon ion laser.

The methods disclosed herein can also include, in some embodiments, optional operation 170, “Recovering the recycled carbon fibers.” In some embodiments, the recycled carbon fibers can be collected by using a smooth plate. In some embodiments, the size of the plate can be larger than the object. The size of the recycled carbon fiber pieces is not particularly limited. For example, the size of the recycled carbon fiber pieces can be about 3 cm to about 14 cm. In some embodiments, the size of the recycled carbon fiber pieces can be about 3 cm, about 4 cm, about 5 cm, about 6 cm, about 7 cm, about 8 cm, about 9 cm, about 10 cm, about 11 cm, about 12 cm, about 13 cm, about 14 cm, or a size between any two of these values. In some embodiments, the size of the recycled carbon fiber pieces can be greater than about 14 cm.

### Systems for Recycling Carbon Fibers

Systems for recycling carbon fibers are also disclosed herein. In some embodiments, the system includes at least one support surface configured to attach to an object, the object including carbon fibers and resin, and at least one light source configured to contact the object with a light beam to produce recycled carbon fibers. In some embodiments, the support surface can be configured to attach to the object such that the object is substantially vertical to the support surface. In some embodiments, the support surface can be configured to attach to the object such that the object is substantially perpendicular to the direction of the light beam. In some embodiments, the support surface can be configured to attach to the object such that the object is substantially horizontal to the support surface. In some embodiments, the support surface includes a sample stage configured to move three-dimensionally. In some embodiments, the light source can be configured to contact the object with the light beam in the absence of a solvent. In some embodiments, the light source can be configured to contact the object with the light beam in the absence of mechanical shearing or chopping.

The amount of time for which the light source can be configured to contact the object with the light beam is not particularly limited. For example, the light source can be configured to contact the object with the light beam for at least about 3 minutes. In some embodiments, the light source can be configured to contact the object with the light beam for about 3 minutes to about 7 minutes. For example, the light source can be configured to contact the object with the light beam for about 3 minutes, about 4 minutes, about 5 minutes, about 6 minutes, about 7 minutes, about 8 minutes, about 9 minutes, about 10 minutes, about 15 minutes, about 20 minutes, about 30 minutes, or a time period between any two of these values. In some embodiments, the light source can be configured to contact the object with the light beam for about 5 minutes. In some embodiments, the light source can be configured to contact the object with the light beam for at least about 7 minutes.

The source from which the light beam is produced is not particularly limited. In some embodiments, the light source is a laser, and the light beam is a laser beam produced from the laser. The type of laser that can be used in the systems disclosed herein is not particularly limited. Any known laser may be used in the systems disclosed herein. For example, the laser can be a carbon dioxide laser, an optical fiber laser, an argon ion laser, or a combination thereof. The power of the light beam produced from the laser can vary. For example, the power can be at least about 30 watts (W). In some embodiments, the light beam produced from the laser can have a power of about 30 W to about 10000 W. For example, in some embodiments, the light beam produced from the laser can have a power of about 30 W, about 32 W, about 34 W, about 36 W, about 38 W, about 40 W, about 42 W, about 44 W, about 46 W, about 48 W, about 50 W, about 60 W, about 70 W, about 80 W, about 90 W, about 100 W, about 110 W, about 120 W, about 140 W, about 160 W, about 180 W, about 200 W, about 300 W, about 400 W, about 500 W, about 1000 W, about 2000 W, about 3000 W, about 4000 W, about 5000 W, about 6000 W, about 7000 W, about 8000 W, about 9000 W, about 10000 W or a power between any two of these values. In some embodiments, the light beam produced from the laser can have a power of about 50 W to about 200 W. In some embodiments, the light beam produced from the laser can have a power of 30 W to 10000 W.

In some embodiments, an infrared thermometer can be used to measure the temperature of the light beam produced from the laser. The temperature of the light beam produced from the laser is not particularly limited. For example, the light beam produced from the laser can have a temperature of about 300° C. to about 600° C. For example, the light beam produced from the laser can have a temperature of about 300° C., 350° C., about 400° C., about 450° C., about 500° C., about 550° C., about 600° C. or a temperature between any two of these values. In some embodiments, the light beam produced from the laser can have a temperature of at least about 300° C., at least about 350° C., at least about 400° C., at least about 450° C., at least about 500° C., at least about 550° C., or at least about 600° C.

The wavelength of the light beam produced from the laser is not particularly limited. For example, the light beam produced from the laser can have a wavelength of about 1.0 μm to about 10.7 μm. In some embodiments, the wavelength of the light beam produced from the laser can be about 1.0 μm, about 1.2 μm, about 1.4 μm, about 1.6 μm, about 1.8 μm, about 2.0 μm, about 3.0 μm, about 4.0 μm, about 5.0 μm, about 6.0 μm, about 7.0 μm, about 8.0 μm, about 9.0 μm, about 10.0 μm, about 10.1 μm, about 10.2 μm, about 10.3 μm, about 10.4 μm, about 10.5 μm, about 10.6 μm, about 10.7 μm or a wavelength between any two of these values.

The ablation rate at the light beam produced from the laser can be configured to contact the object is also not particularly limited. In some embodiments, the light beam produced from the laser can be configured to contact the object at an ablation rate of about 1 cm/minute to about 2 cm/minute. For example, the light beam produced from the laser can be configured to contact the object under an ablation rate of about 1 cm/minute, about 1.1 cm/minute, about 1.2 cm/minute, about 1.3 cm/minute, about 1.4 cm/minute, about 1.5 cm/minute, about 1.6 cm/minute, about 1.7 cm/minute, about 1.8 cm/minute, about 1.9 cm/minute, about 2 cm/minute, or a rate between any two of these values.

In some embodiments, the light beam contacting the object can be expanded. In some embodiments, expanding the light beam contacting the object can include expanding the light beam using an optical device that can expand the size of the light beam. For example, the system can include a beam expander configured to expand the light beam contacting the object. In some embodiments, the beam expander is a multiple-prism beam expander, a telescopic beam expander, a diverging lens, or a combination thereof. In some embodiments, the system can include a reflective mirror configured to adjust an angle of the light beam contacting the object.

In some embodiments, one or both of the support surface and the light beam can be configured to move to contact the object with the light. In some embodiments, the support surface can be configured to move relative to the light beam at a velocity of about 1 cm/minute to about 2 cm/minute. In some embodiments, the support surface can be configured to move relative to the light beam at a velocity of about 1 cm/minute, about 1.1 cm/minute, about 1.2 cm/minute, about 1.3 cm/minute, about 1.4 cm/minute, about 1.5 cm/minute, about 1.6 cm/minute, about 1.7 cm/minute, about 1.8 cm/minute, about 1.9 cm/minute, about 2 cm/minute, or a velocity between any two of these values. In some embodiments, the light beam is configured to move relative to the support surface at a velocity of about 1 cm/minute to about 5 cm/minute. For example, in some embodiments, the light beam can be moved relative to the support surface at a velocity of about 1 cm/minute, about 1.1 cm/minute, about 1.2 cm/minute, about 1.3 cm/minute, about 1.4 cm/minute, about 1.5 cm/minute, about 1.6 cm/minute, about 1.7 cm/minute, about 1.8 cm/minute, about 1.9 cm/minute, about 2 cm/minute, about 2.2 cm/minute, about 2.4 cm/minute, about 2.6 cm/minute, about 2.8 cm/minute, about 3.0 cm/minute, about 3.2 cm/minute, about 3.4 cm/minute, about 3.6 cm/minute, about 3.8 cm/minute, about 4.0 cm/minute, about 4.2 cm/minute, about 4.4 cm/minute, about 4.6 cm/minute, about 4.8 cm/minute, about 5.0 cm/minute, or a velocity between any two of these values. In some embodiments, the light source is an optical fiber laser, and moving the light beam can include moving an optical fiber of the optical fiber laser. The velocity at which the optical fiber of the laser is moved is not particularly limited and can be as described above for the velocity of the light beam with respect to the support surface.

In some embodiments, the light source can be further configured to contact air between the produced recycled carbon fibers and the light source to provide a hot airflow to the recycled carbon fibers to remove the resin. In some embodiments, the system can further include the object attached to the support surface, the object including carbon fibers and resin.

### EXAMPLES

Additional embodiments are disclosed in further detail in the following examples, which are not in any way intended to limit the scope of the claims.

### Example 1

First Scheme for Recycling Carbon Fibers: Contacting with Carbon Dioxide Laser

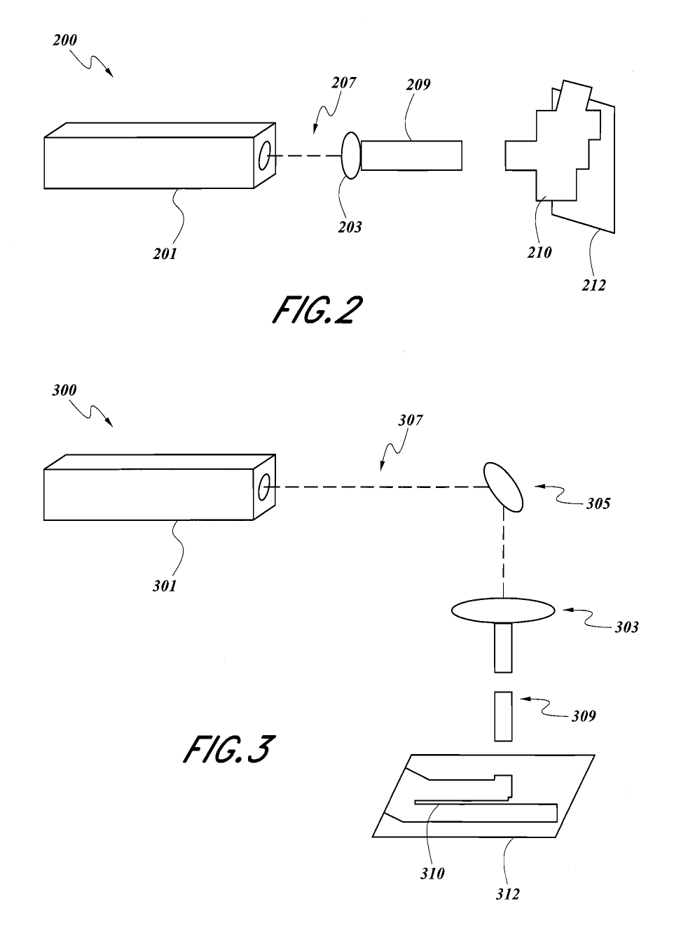

A sample piece of carbon fiber reinforced polymer 212 is selected. The carbon fiber reinforced polymer 212 includes carbon fibers in a resin matrix. The sample piece 212 is fixed vertically onto a sample stage capable of moving three-dimensionally, and arranged perpendicular to a light beam produced by a carbon dioxide laser device 201. The surface of the sample piece 212 is irradiated with the light beam 207 from the carbon dioxide laser device 201 after passing through a beam expander 203 to form an expanded light beam 209. The width of the expanded light beam 209 can vary according to the size of the sample piece 212 to be treated, with traces of the treated areas 210 of the sample piece 212 visible. For a sample piece 212 with a large area, expansion of the light beam 207 is performed with the beam expander 203 to increase the area of irradiation. For a sample piece 212 with a small area, irradiation is performed with an unexpanded light beam 207 or a focused light beam. The speed and direction of the motion of the sample stage are controlled according to the power of the laser device 201 such that recycled carbon fibers are fully separated from the resin matrix. When the power of the laser device 201 is high, the speed of motion can be fast. When the power of the laser device 201 is low, the speed of motion can be slow. A schematic diagram of Scheme 200 is depicted in FIG. 2.

### Example 2

Second Scheme for Recycling Carbon Fibers: Contacting with Carbon Dioxide Laser

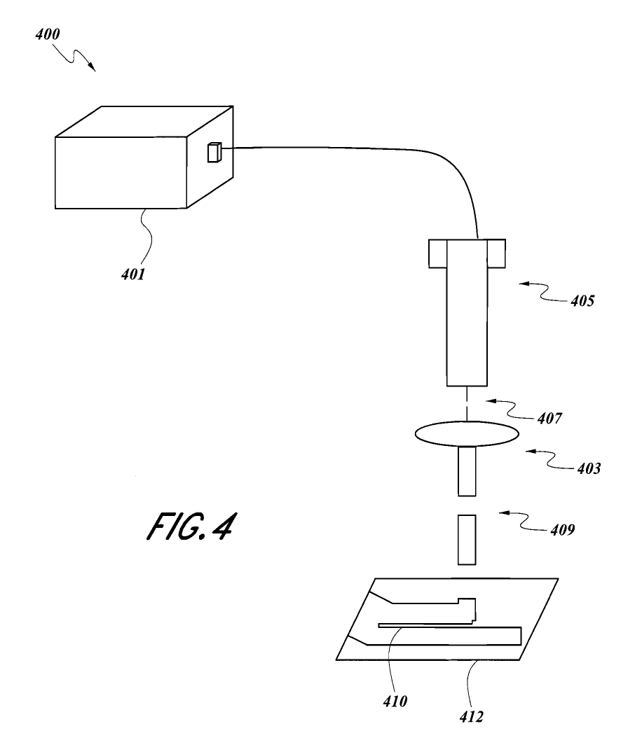

A sample piece of carbon fiber reinforced polymer 312 is selected. The piece 312 is fixed horizontally onto a sample stage capable of moving three-dimensionally, with its surface being horizontal to the sample stage. The light beam 307 of a carbon dioxide laser device 301 is adjusted to point vertically downwards onto the sample piece 312 by using a reflective mirror 305 with an angle of 45° to the light beam 307. The surface of the sample piece 312 is irradiated with the light beam 307 after passing through a beam expander 303 to form an expanded light beam 309, with traces of the treated areas 310 of the sample piece 312 visible. The speed and direction of the motion of the sample stage are controlled according to the power of the laser device 301 such that recycled carbon fibers are fully separated from the resin matrix. When the power of the laser device 301 is high, the speed of motion can be fast. When the power of the laser device 301 is low, the speed of motion can be slow. A schematic diagram of Scheme 300 is depicted in FIG. 3.

### Example 3

Third Scheme for Recycling Carbon Fibers: Contacting with Optical Fiber Laser

A sample piece of carbon fiber reinforced polymer 412 is selected. The sample piece 412 is fixed horizontally onto a sample stage configured to move three-dimensionally. An optical fiber 405 of an optical fiber laser device 401 is adjusted such that the direction of its light beam 407 is perpendicular to the surface of the sample piece 412. The surface of the sample piece 412 is irradiated with the light beam 407 after passing through a beam expander 403 to form an expanded light beam 409, with traces of treated areas 410 of the sample piece 412 visible. The sample stage is kept still while the motion of the expanded light beam 409 from the optical fiber laser device 401 was controlled. When the power of the laser device 401 is high, the speed of motion can be fast. When the power of the laser device 401 is low, the speed of motion can be slow. Alternatively, the optical fiber laser device 401 is kept still while the motion of the sample stage is controlled. In another variation, the relative motions of the expanded light beam 409 of the optical fiber laser device 401 and the sample stage are controlled substantially simultaneously. The expanded light beam 409 contacts a polymer matrix on the support surface, thereby obtaining recycled carbon fibers. A schematic diagram of Scheme 400 is depicted in FIG. 4.

### Example 4

Recycling Carbon Fibers Using the First Scheme: Contacting with Carbon Dioxide Laser

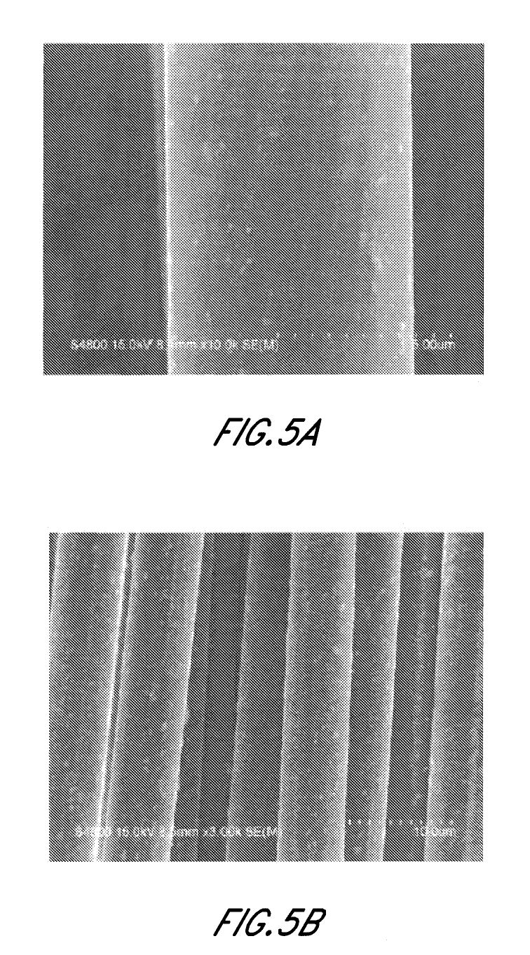

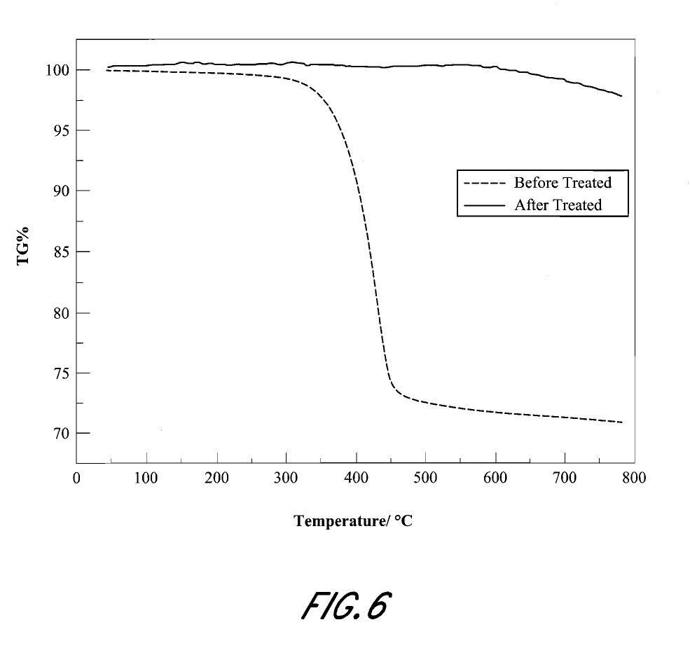

A sample piece of carbon fiber reinforced epoxy resin-based polymer was selected and vertically fixed onto a support surface. The carbon fiber reinforced polymer sample piece includes carbon fibers in a resin matrix. The sample piece was irradiated with a horizontal light beam produced from a carbon dioxide laser device. The sample was fixed on a sample stage capable of moving three-dimensionally. The horizontal light beam was perpendicular to the vertically fixed sample piece. The wavelength of the light beam was 10.7 μm. The power of the light beam was set to 50 W and the light beam was contacted with the sample piece for 5 minutes. The resin matrix was removed from the sample piece by a hot airflow formed by the light beam to obtain recycled carbon fibers. FIGS. 5A and 5B show scanning electron microscope (SEM) images of recycled carbon fibers obtained by irradiating the sample piece of carbon fiber reinforced polymer with the light beam produced from the carbon dioxide laser. The SEM images show that the carbon fibers were separated from the resin matrix with no surface damage. FIGS. 5A and 5B also show that the carbon fibers had a smooth surface and were substantially free of surface defects. FIGS. 5A and 5B further show that the carbon fibers maintained an orderly and uniform orientation after being recovered from the carbon fiber reinforced polymer sample. FIG. 6 shows the corresponding thermogravimetric analysis (TGA) plot of carbon fibers recovered by irradiating the sample piece of carbon fiber reinforced polymer with the light beam produced from the carbon dioxide laser. FIG. 6 shows that the epoxy resin has been substantially degraded.

Therefore, Example 4 shows that a simple method of contacting carbon fiber reinforced polymer sample with a light beam, without requiring other methods steps such as contacting the sample with solvents which can be toxic, results in effective and rapid separation of the carbon fibers from the sample. The carbon fibers that are recovered have been shown to be substantially free of surface defects and maintain a uniform and orderly orientation which suggests that the carbon fibers are expected to maintain good mechanical properties after the recovery.

### Example 5

Recycling Carbon Fibers Using the First Scheme: Contacting with Carbon Dioxide Laser

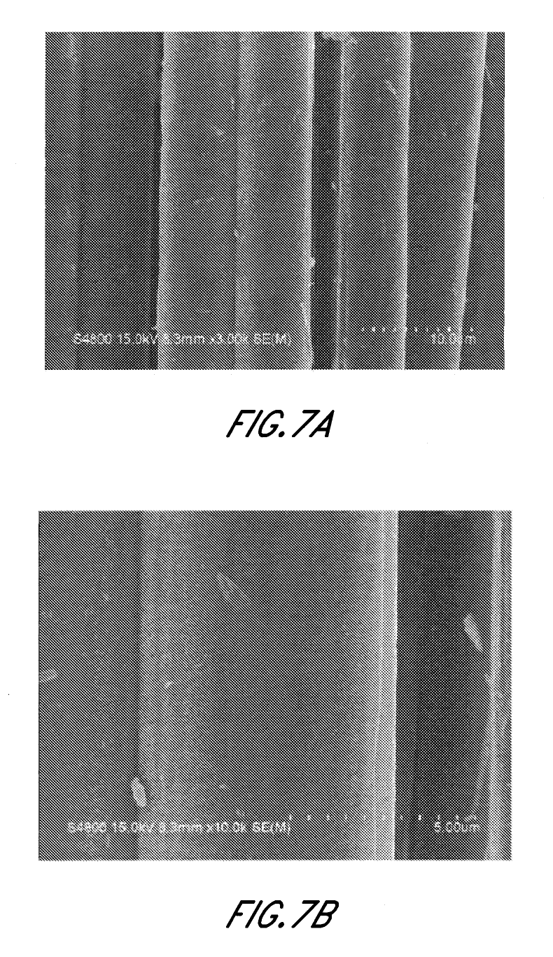

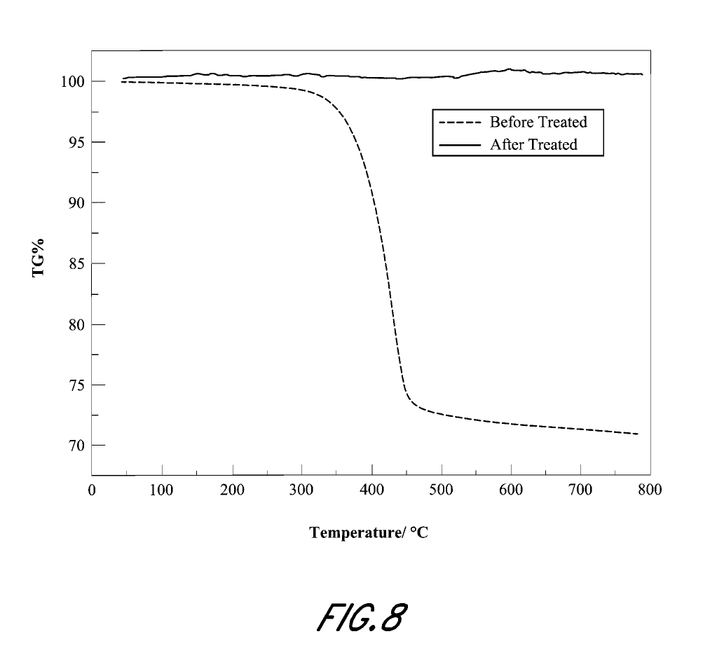

A piece of carbon fiber reinforced epoxy resin-based polymer sample was selected and treated according to the general procedure described in Example 1 (Scheme 200) to recover carbon fibers. The laser power was controlled at 50 W and the sample was treated by moving the sample stage relative to the light beam at a velocity of 1 cm/minute. FIGS. 7A and 7B show scanning electron microscope (SEM) images of recycled carbon fibers after the treatment of irradiating the carbon fiber reinforced polymer sample with a light beam produced from a carbon dioxide laser and moving the sample stage. FIGS. 7A and 7B show that there was very little resin residue left on the surfaces of the recycled carbon fibers under these conditions and no damage was observed on the surface of the carbon fibers. FIG. 8 shows the corresponding thermogravimetric analysis (TGA) plot of the recycled carbon fibers. FIG. 8 shows that the polymer has been substantially degraded. Accordingly, Example 5 shows that a simple method of contacting carbon fiber reinforced polymer sample with a light beam, without requiring other methods steps such as contacting the sample with solvents which can be toxic, results in effective and rapid separation of the carbon fibers from the sample. The carbon fibers that are recovered have been shown to be substantially free of surface defects and maintain a uniform and orderly orientation which suggests that the carbon fibers are expected to maintain good mechanical properties after the recovery.

### Example 6

Recycling Carbon Fibers Using the Second Scheme: Contacting with Carbon Dioxide Laser

A sample piece of carbon fiber reinforced epoxy resin-based polymer is selected and treated according to the general procedure described in Example 2 (Scheme 300) to recover carbon fibers. The laser power is controlled at 100 W and the sample piece is treated by moving the sample stage relative to the light beam to obtain recycled carbon fibers. The resin matrix is removed by a hot airflow formed by the light beam. It will be determined via scanning electron microscope (SEM) imaging that the recycled carbon fibers will be substantially free of polymer residue and will be substantially free of surface defects. A corresponding thermogravimetric analysis (TGA) plot will also show that the polymer has been substantially degraded. Accordingly, Example 6 will show that a simple method of contacting carbon fiber reinforced polymer sample with a light beam, without requiring other methods steps such as contacting the sample with solvents which can be toxic, can result in effective and rapid separation of the carbon fibers from the sample. The carbon fibers that are recovered will be substantially free of surface defects and maintain a uniform and orderly orientation, which would suggest that the carbon fibers are expected to maintain good mechanical properties after the recovery.

### Example 7

Recycling Carbon Fibers Using the Third Scheme: Contacting with Optical Fiber Laser

A sample piece of carbon fiber reinforced epoxy resin-based polymer is selected and treated according to the general procedure described in Example 3 (Scheme 400) to recover carbon fibers. The laser power is controlled at 200 W and the sample is treated by moving the sample stage relative to the light beam, or moving the optical fiber of the laser device relative to the sample stage, or moving both the sample stage and the optical fiber at the same time. It will be found via scanning electron microscope (SEM) imaging that the recycled carbon fibers will be substantially free of polymer residue and will be substantially free of surface defects. A corresponding thermogravimetric analysis (TGA) plot will also show that the polymer has been substantially degraded. Accordingly, Example 7 will show that a simple method of contacting carbon fiber reinforced polymer sample with a light beam, without requiring other methods steps such as contacting the sample with solvents which can be toxic, can result in effective and rapid separation of the carbon fibers from the sample. The carbon fibers that are recovered will be substantially free of surface defects and maintain a uniform and orderly orientation, which would suggest that the carbon fibers are expected to maintain good mechanical properties after the recovery.

With respect to the use of substantially any plural and/or singular terms herein, those having skill in the art can translate from the plural to the singular and/or from the singular to volume of wastewater can be received in the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

1. A method of recycling carbon fibers, the method comprising:
providing at least one object comprising carbon fibers and resin;
irradiating the at least one object with at least one light beam to produce recycled carbon fibers; and
recovering the recycled carbon fibers from the at least one object.

2-7. (canceled)

8. The method of claim 1, further comprising at least one support surface including a sample stage configured to move three-dimensionally.

9. The method of claim 1, wherein irradiating the at least one object with the at least one light beam is performed in the absence of one or more solvents.

10. The method of claim 1, wherein irradiating the at least one object, with the at least one light beam is performed in the absence of mechanical shearing or chopping.

11. (canceled)

12. The method of claim 1, wherein irradiating the at least one object with the at least one light beam comprises applying the at least one light beam to the at least one object for about 3 minutes to about 7 minutes.

13. The method of claim 1, wherein the at least one light beam is produced from a laser.

14. (canceled)

15. The method of claim 13, wherein the at least one light beam produced from the laser has a power of about 50 W to about 200 W.

16. The method of claim 13, wherein the at least one light beam produced from the laser has a temperature of about 300° C. to about 600° C.

17. The method of claim 13, wherein the at least one light beam produced from the laser has a wavelength of about 1.0 μm to about 10.7 μm.

18. (canceled)

19. The method of claim 13, wherein the laser is a carbon dioxide laser, an optical fiber laser, or an argon ion laser.

20. (canceled)

21. (canceled)

22. The method of claim 1, further comprising expanding the at least one light beam irradiating the at least one object.

23. (canceled)

24. The method of claim 1, further comprising adjusting an angle of the at least one light beam irradiating the at least one object.

25. The method of claim 24, wherein adjusting the angle of the at least one light beam comprises adjusting the angle of the at least one light beam using a reflective mirror.

26. (canceled)

27. The method of claim 1, further comprising moving the at least one support surface relative to the at least one light beam at a velocity of about 1 cm/min to about 2 cm/min.

28. The method of claim 1, further comprising moving the at least one light beam relative to the at least one support surface at a velocity of about 1 cm/min to about 5 cm/min.

29. (canceled)

30. (canceled)

31. The method of claim 1, further comprising removing resin from the recycled carbon fibers by hot airflow.

32. (canceled)

33. (canceled)

34. A system for recycling carbon fibers, the system comprising:
at least one support surface configured to attach to at least one object, the at least one object comprising carbon fibers and resin;
at least one light source configured to irradiate the at least one object with at least one light beam to produce recycled carbon fibers; and
at least one device configured to remove the recycled carbon fibers from the at least one object.

35-37. (canceled)

38. The system of claim 34, wherein the at least one support surface comprises a sample stage configured to move three-dimensionally.

39. (canceled)

40. (canceled)

41. The system of claim 34, wherein the at least one light source is a laser, and the at least one light beam is produced from the laser.

42. (canceled)

43. The system of claim 41, wherein the at least one light beam produced from the laser has a power of about 50 W to about 200 W.

44. The system of claim 41, wherein the at least one light beam produced from the laser has a temperature of about 300° C. to about 600° C.

45. The system of claim 41, wherein the at least one light beam produced from the laser has a wavelength of about 1.0 μm to about 10.7 μm.

46. (canceled)

47. The system of claim 41, wherein the laser is a carbon dioxide laser, an optical fiber laser, or an argon ion laser.

48. (canceled)

49. (canceled)

50. The system of claim 34, further comprising a beam expander configured to expand the at least one light beam irradiating the at least one object.

51. The system of claim 34, further comprising a reflective mirror configured to adjust an angle of the at least one light beam irradiating the at least one object.

52. (canceled)

53. The system of claim 34, wherein the at least one support surface is configured to move relative to the at least one light beam at a velocity of about 1 cm/min to about 2 cm/min.

54. The system of claim 34, wherein the at least one light beam is configured to move relative to the at least one support surface at a velocity of about 1 cm/min to about 5 cm/min.

55. The system of claim 34, wherein the at least one light beam is configured to contact air between the recycled carbon fibers and the at least one light source to provide a hot airflow to the recycled carbon fibers to remove the resin.

56. (canceled)

57. The method of claim 1, wherein the recycled carbon fibers that are recovered from the at least one object are substantially free of the resin.

58. The system of claim 34, wherein the at least one device configured to remove the recycled carbon fibers from the at least one object comprises a smooth plate.

59. A method of recycling carbon fibers, the method comprising:
providing at least one object comprising carbon fibers and resin on at least one support surface;
irradiating the at least one object with at least one light beam to produce recycled carbon fibers;
at least one of:
moving the at least one support surface relative to the at least one light beam at a velocity of about 1 cm/min to about 2 cm/min; or
moving the at least one light beam relative to the at least one support surface at a velocity of about 1 cm/min to about 5 cm/min;
removing resin from the recycled carbon fibers by hot air flow; and
recovering the recycled carbon fibers from the at least one object.
